(19) United States
(12) Patent Application Publication
(10) Pub. No.: US 2026/0086934 A1
(43) Pub. Date: Mar. 26, 2026

(54) MULTI-DOMAIN HARDWARE MEMORY COMPRESSION

(71) Applicant: VIRGINIA TECH INTELLECTUAL PROPERTIES, INC., Blacksburg, VA (US)

(72) Inventor: Xun Jian, Christiansburg, VA (US)

(21) Appl. No.: 19/338,109

(22) Filed: Sep. 24, 2025

Related U.S. Application Data
(60) Provisional application No. 63/698,304, filed on Sep. 24, 2024.

(51) Int. Cl. G06F 12/02; G06F 12/06

(52) U.S. Cl. CPC G06F 12/023; G06F 12/0653

(57) ABSTRACT

An example computing system includes one or more memories and a controller configured to manage allocation of the one or more memories to a process based on one or more allocation objectives received from an operating system (OS). To manage allocation of the one or more memories to the process, the controller is further configured to determine a quantity of available memory in the one or more memories, allocate a portion of the quantity of available memory to the process, map the portion that is allocated to the process to a control block, map a plurality of physical pages used by the process to the control block, where the plurality of physical pages is associated with a memory managed by the OS, and determine whether to compress the plurality of physical pages based at least in part on an OS-writeable objective field contained in the control block.

### CROSS-REFERENCE TO RELATED APPLICATION

This application claims the benefit of and priority to U.S. Provisional Patent Application No. 63/698,304, filed Sep. 24, 2024, entitled “MEMORY ALLOCATION UNDER HARDWARE COMPRESSION,” the content of which is hereby incorporated herein by reference in its entirety. This application is also related to U.S. Non-Provisional patent application Ser. No. 18/901,218, entitled “DEMAND-ADAPTIVE MEMORY COMPRESSION IN HARDWARE,” the content of which is hereby incorporated herein by reference in its entirety.

### STATEMENT REGARDING FEDERALLY SPONSORED RESEARCH OR DEVELOPMENT

This invention was made with government support under grant numbers 1942590, 1919113, and 2312785 awarded by the National Science Foundation (NSF). The government has certain rights in the invention.

### BACKGROUND

Computer memory has undergone transformations over the years, evolving from relatively simple and expensive components to complex and costly resources, especially in the context of today's data-intensive applications. Today, many applications in the fields of video editing, gaming, machine learning, and big data, among others, require large amounts of memory. Different types of memories can include dynamic random-access memory (DRAM), static random-access memory (SRAM), and non-volatile memory (NVM), to name a few. High-performance computing in the fields like artificial intelligence (AI), scientific research, simulation, and high-performance computing systems may require vast amounts of DRAM to handle the huge datasets they process.

DRAM density scaling has been increasingly lagging behind other components such as NAND flash memory, double data rate (DDRx) DRAM, and non-volatile RAM (NVRAM), to name a few examples. Unlike CPU scaling, DRAM scaling faces challenges such as scaling not only transistors but also capacitors, which can be difficult as smaller capacitors hold less charge. As DRAM scaling slows physically, memory compression can function as a promising solution to scale DRAM density logically. Meta® data centers report that their workloads have a high average memory compression ratio of 3×, where compression ratio refers to memory footprint after compression (assuming every compressible page is compressed). As such, hyperscale data centers (e.g., Meta® and Google®) generally use operating system (OS) memory compression.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a computing system for multi-domain hardware memory compression according to various embodiments of the present disclosure.

FIG. 2 depicts a system diagram showing connections between a controller, a processor, and a memory in association with the computing system shown in FIG. 1, according to various embodiments of the present disclosure.

FIG. 3 depicts an overview of a compression engine shown in the computing system of FIG. 1 and how the compression engine interacts with various components of the computing system shown in FIG. 1, according to various embodiments of the present disclosure.

FIG. 4 depicts an objective based allocation process implementable in the computing system shown in FIG. 1 according to various embodiments of the present disclosure.

FIG. 5 depicts a flowchart summarizing the benefits of the objective based allocation process shown in FIG. 4, according to various embodiments of the present disclosure.

FIG. 6 depicts a diagram of mappings between the compression engine of the computing system shown in FIG. 1 and physical and virtual pages for multiple processes, according to various embodiments of the present disclosure.

FIG. 7 depicts memory ranges of a physical memory shown in FIG. 4 and the memory shown in FIG. 1, according to various embodiments of the present disclosure.

FIG. 8 depicts a ring of control blocks implementable in the computing system shown in FIG. 1, according to various embodiments of the present disclosure.

FIG. 9 depicts various fields contained in a single control block, according to various embodiments of the present disclosure.

FIG. 10 depicts a diagram of how the compression engine shown in the computing system of FIG. 1 can enforce memory allocation objectives according to various embodiments of the present disclosure.

FIG. 11 depicts a computing system for multi-domain hardware memory compression, with summarized interactions between a controller and an operating system (OS), according to various embodiments of the present disclosure.

FIG. 12 depicts an example method for multi-domain hardware memory compression that can be implemented by the controller shown in the computing systems of FIGS. 1 and 11, according to various embodiments of the present disclosure

### DETAILED DESCRIPTION

Computer memory has undergone transformations over the years, evolving from relatively simple and expensive components to complex and costly resources, especially in the context of today's data-intensive applications. Today, many applications in the fields of video editing, gaming, machine learning, and big data, among others, require large amounts of memory. Different types of memories can include dynamic random-access memory (DRAM), static random-access memory (SRAM), and non-volatile memory (NVM), to name a few. High-performance computing in the fields like artificial intelligence (AI), scientific research, simulation, and high-performance computing systems may require vast amounts of DRAM to handle the huge datasets they process.

DRAM density scaling has been increasingly lagging behind other components such as NAND flash memory, double data rate (DDRx) DRAM, and non-volatile RAM (NVRAM), to name a few examples. Unlike CPU scaling, DRAM scaling faces challenges such as scaling not only transistors but also capacitors, which can be difficult as smaller capacitors hold less charge. As DRAM scaling slows physically, memory compression can function as a promising solution to scale DRAM density logically. Meta® data centers report that their workloads have a high average memory compression ratio of 3×, where compression ratio refers to memory footprint after compression (assuming every compressible page is compressed). As such, hyperscale data centers (e.g., Meta® and Google®) generally use operating system (OS) memory compression.

Unfortunately, OS memory compression incurs costly OS overheads. For example, whenever a process accesses an OS-compressed virtual page, the memory management unit (MMU) can incur a costly page fault to wake up the OS to expand the virtual page to a full physical page. As such, data centers can only compress a small fraction of the total pages, such as only the extremely cold pages and save little (e.g., 5%-20%) of memory. This is a far cry from what can be theoretically saved given the high memory compression ratio of typical workloads.

Prior works have explored hardware memory compression, where the memory controller in a CPU transparently compresses and decompresses memory values. Unlike traditional systems, where physical memory is actual memory (i.e., DRAM), hardware-compressed memory decouples physical memory from actual memory. The memory controller can spend a varying amount of DRAM on each physical page according to the compression ratio of its content. This decoupling can complicate memory management, however. For example, machine-physical memory (i.e., DRAM) can run out when physical memory (e.g., memory in an OS or managed by an OS) is still abundant. Decoupling physical and machine-physical memory can also complicate memory allocation. Memory allocation, such as giving or allocating memory to a process or group of related processes, is required to ensure stable or predictable performance and even correctness. In traditional systems without hardware compression, memory allocation is precise. For example, after a cloud user specifies and pays for N GB of memory for his/her VM, the host can, and typically will, precisely allocate N GB of actual memory to the VM, regardless of whether the VM's guest OS is compressing memory internally. By decoupling physical memory and machine-physical memory, however, hardware memory compression can make memory allocation imprecise and sometimes almost infeasible under existing memory allocation interfaces.

Memory allocation can be imprecise under hardware memory compression since the actual size of each physical page can vary dynamically according to the compression ratio of the page, to precisely allocate the specified S amount of actual memory (i.e., machine-physical memory) to a process/job, the OS cannot simply allocate to it S amount of physical memory, such as in traditional systems. A plausible option could be to allocate S. C amount of physical memory, where C is the job's compression ratio, but since compression ratio is an application-level characteristic that is uncontrollable by and often unknown to the OS, the OS does not know how much physical memory to allocate. Overestimating or underestimating a job's compression ratio can make the allocated machine-physical memory several times more or less than specified and, therefore, imprecise.

Memory allocation can be sometimes almost infeasible since the OS generally allocates physical pages to a process by pairing them with the virtual pages that the process is currently using. When every in-use virtual page in a process already has a physical page (e.g., when the process is fully in memory, without anything swapped out), the OS cannot allocate meaningfully more physical pages to the process and, thus, cannot allocate to it more machine-physical memory. If such processes (i.e., process that are fully in memory) could be allocated more machine-physical memory, they could still benefit from having more of their data decompressed and faster to access.

Allocating less memory to a job, either due to allocating imprecisely or not being able to allocate can mean more of the job's physical pages must be compressed and more of its accesses will suffer from decompression and additional translation overheads. Obtaining significantly less memory than specified can even cause a job to spill out to swap and slow down even more. In a highly consolidated memory system, where compression is useful, even imprecisely allocating more memory to a job can be harmful as this can lead to allocating less memory to other jobs and harming performance.

Every layer of memory (e.g., virtual, pseudo-physical, physical) has its own specialized memory allocation interface (e.g., malloc/mmap for virtual memory and page tables and MMU for physical memory). However, there is an exception for the machine-physical memory that hardware memory compression decouples from physical memory. Trying to make do without a specialized memory allocation interface for this new layer of memory naturally gives rise to various memory allocation problems.

Unlike the various layers of logical (e.g., virtual, pseudo-physical) memory, which are generally needed for correctness, actual memory or machine-physical memory as referred to herein (e.g., DRAM) is generally needed for performance. Programs can run correctly on swap alone, with little or no actual memory. The more actual memory, the less frequent are costly events such as swapping in/out, memory compression/decompression, OS file cache misses for storage intensive applications, and garbage collection for Java and other managed programs.

In multi-tenant systems (e.g., cloud, cluster, etc.), consolidating more jobs per server requires allocating to each job the minimum memory the job needs to meet its performance needs. Excluding special cases, the host does not know how much memory each job needs for performance. This knowledge can depend on complex factors such as current input data size, classification of important processes in a virtual machine (VM), execution times of these processes, and how they vary with memory. The host is generally unaware of these aforementioned factors that determine each job's induvial memory needs.

Further, requiring users to expose some of these factors (e.g., what are the current inputs) can also raise privacy concerns that go against the emerging trend of confidential computing. As such, multi-tenant systems can universally require users to specify the actual memory they need for performance. The host can then precisely allocate the specified actual memory, so that users need not worry about the host being a potential cause when the jobs' memory-related performance is poor. Imprecisely allocating more memory to a job in this context can be harmful as it can lead to imprecisely allocating less memory to other jobs.

Hardware memory compression reduces physical memory to a logical memory layer. As such, when specifying how much actual memory (e.g., machine-physical memory) the jobs need for performance, users may specify machine-physical memory instead of physical memory (e.g., memory managed by the OS). Meanwhile, for service providers, reliably meeting user requests for machine-physical memory can also be easier than meeting user requests for physical memory. To precisely allocate a specified S amount of machine-physical memory to a process or job, an OS cannot simply allocate S amount of physical memory, like in traditional systems. This is because hardware-compressed memory spends a dynamically varying amount of machine-physical memory on each physical page, depending on how compressible its values are. A plausible option can be to allocate an S. C amount of physical memory, as mentioned before, where C is a job's compression ratio. However, a program's compression ratio is uncontrollable by and often unknown to an OS, an OS may not know how much physical memory to allocate to the job.

In some instances, an OS may perhaps pessimistically assume a low compression ratio of 1 (i.e., assume nothing is compressible). This means allocating only as many physical pages as the machine-physical pages in the system (and not more). This may yield no benefit (i.e., no increase in effective capacity) and only loss (i.e., compressed data are slower to access). To get strong benefit (i.e., much more than OS compression), the OS can perhaps optimistically assume a high (e.g., 4×) compression ratio. When assuming 4×, allocating a specified S amount of machine-physical memory can mean allocating 4S physical memory. For jobs with <4× compression ratios (e.g., 2×), this means allocating more machine-physical memory than specified (e.g., by 4×/2=2×).

When prior hardware compression methods run low on free machine-physical memory (e.g., due to imprecisely allocating too much memory), many memory accesses from user jobs must be blocked to make time to slowly spill out data and free up enough machine-physical memory to safely avoid deadlock. Meanwhile, the OS neither knows nor controls the compression ratio of each job. As such, the OS does not know which jobs are using too much machine-physical memory and, therefore, cannot surgically block and spill out data only from offending jobs (e.g., by inflating the memory balloons in their VMs). As such, all jobs can slow down significantly.

Even when all processes are fully in-memory, with nothing spilled out, imprecise memory allocation can still be harmful. Imprecisely allocating more memory to Job A (e.g., because it is less compressible than estimated) may mean needing to compress another Job B more aggressively. This can slow down Job B in an unpredictable manner that depends on the compression ratio of Job A. The problem gets worse under recency aware compression, which can selectively compress colder data. Jobs that access memory less often than other jobs can get over-compressed.

Ideally, each job should be compressed into its specified memory (e.g., into 100 GB if it specifies 100 GB) and not get over-compressed (e.g., down to 20 GB) when a collocated job is less compressible and/or more memory-intensive than the original job. The OS, however, has no means of asking hardware to spend more memory on the ‘over-compressed’ victim job (e.g., the Job B), so that more of its pages can become uncompressed. When allocating machine-physical memory indirectly through allocating physical memory, the OS cannot allocate more machine-physical memory to a process that cannot be allocated more physical memory. Conversely, for a job that is taking up too much machine-physical memory due to being more memory-intensive and thus evading compression under recency-aware compression, the OS has no way of instructing the memory controller to spend less machine-physical memory on it (i.e., to compress more).

To address the problem of imprecise allocation, a plausible solution can be to modify the OS to periodically sample the compression ratios of allocated physical pages (e.g., by reading their content) and, in turn, estimate each job's compression ratios. Periodic sampling raises the question of precision, especially for short-lived processes like function-as-a-service (FaaS) and micro-services. Periodic sampling can also introduce new continuous OS overhead that is not even in OS memory compression and, thus, contradicts the goal of hardware memory compression-reducing OS overheads for compression. The alternative of users sampling compression ratios, instead of the host OS, and then reporting them to the host OS can burden the users and raise new trust concerns for the service providers. Furthermore, a faulty sampling can cause system-level problems (e.g., system running out of memory), unlike the various types of user-level sampling being performed today, where faulty sampling can only affect that user's program.

In comparison, when the guest OS performs memory compression in traditional systems, neither the system nor the users sample compression ratios. Instead, the VMs can only use up to the memory that they booted up with, regardless of the compression ratio of their workloads. In other words, memory allocation remains precise under OS memory compression. This is because the host OS directly allocates machine-physical memory (as physical memory is machine-physical memory in traditional systems) and need not use compression ratios to reverse engineer how much physical memory to approximate the desired amount of machine-physical memory to allocate.

Therefore, various embodiments of the present disclosure are directed toward systems and methods for a MMU-like component to enable an OS to directly allocate machine-physical memory and, thus, avoid problems due to allocating machine-physical memory indirectly through allocating physical memory. Throughout the description of the embodiments in the present disclosure, machine-physical memory refers to actual physical memory such as DRAM and other types of memory such as static RAM (SRAM), magnetoresistive RAM (MRAM), ferroelectric RAM (FRAM), NVRM, and possibly other types memories. Physical memory refers to the memory in the OS or managed by the OS, which would be an abstraction of the machine-physical memory.

The embodiments include a specialized interface for machine-physical memory which encompasses an objective-based allocation method that allows an OS to directly express how much machine-physical memory to allocate to individual jobs to precisely satisfy user-specified memory needs. Exposing how much memory a controller (e.g., memory controller) has freed from a job so that the OS can reallocate them is simpler than exposing which pages the controller has freed. The embodiments incorporate allocation objectives for a job by guiding the controller to compress the job precisely down to an allocated amount of machine-physical memory. If not compressed enough, the controller can raise a fault (like a page fault) to assist the OS with spilling out the job.

Therefore, various embodiments of the present disclosure include a computing system including one or more memories and a controller configured to manage allocation of the one or more memories to a process based on one or more allocation objectives received from an operating system (OS). To manage allocation of the one or more memories to the process, the controller is further configured to determine a quantity of available memory in the one or more memories, allocate a portion of the quantity of available memory to the process, map the portion that is allocated to the process to a control block among a plurality of control blocks, map a plurality of physical pages used by the process to the control block, where the plurality of physical pages is associated with a memory managed by the OS, and determine whether one or more physical pages of the plurality of physical pages should be compressed based at least in part on an OS-writeable objective field contained in the control block.

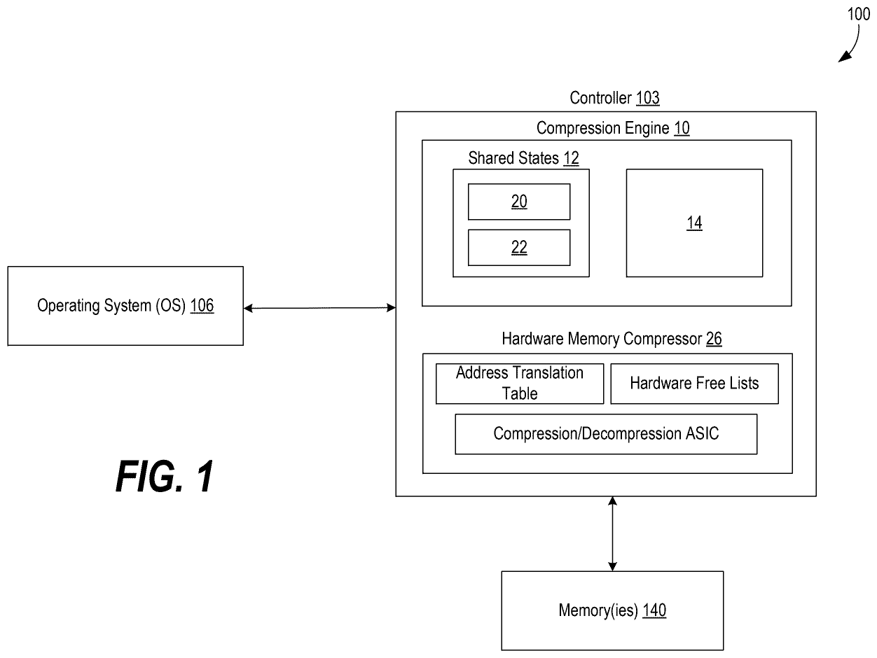

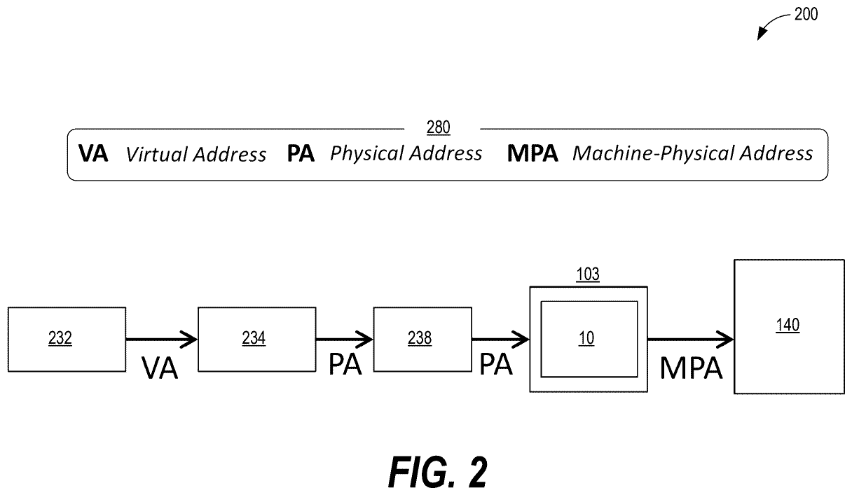

Referring to the drawings, FIG. 1 depicts a computing system 100 for multi-domain hardware memory compression, and FIG. 2 depicts a system diagram 200 showing connections between a controller, a processor, and a memory in association with the computing system 100, according to various embodiments of the present disclosure. FIG. 1 is not exhaustively illustrated, meaning that other components not shown in FIG. 1 can be included or relied upon in some cases. Alternatively, one or more components shown in FIG. 1 can be omitted in some cases.

The computing system 100 includes a controller 103, a multi-domain compression engine 10 (“compression engine 10” for short) in the controller 103, one or more memories 140 (“the memory 140” for short), and an operating system (OS) 106. The memory 140 can include various types of machine-physical memory such as DRAM, SRAM, NVRAM, and MRAM, among others. The controller 103 can include a CPU memory controller or other types of memory controllers that may be in data communication with a CPU.

The compression engine 10 can include various logic such as shared states 12, which can store recency nodes 20 and control blocks 22 that can be shared among a network of jobs or processes, which are managed by the OS 106. The compression engine 10 also includes a backend microarchitecture 14, which can be configured to enforce various allocation objectives specified by the OS 106, by receiving guided data from the recency nodes 20 and the control blocks 22, and update the recency nodes 20 and the control blocks 22. The controller 103 also includes a hardware memory compressor 26 which can be embodied as an underlying hardware memory compressor that includes a compression/decompression application-specific integrated circuit (ASIC), address translation tables, and hardware free lists. Additional examples of the hardware memory compressor 26 are described in U.S. patent application Ser. No. 18/901,218, at least at paragraphs [0043]-[0046], [0061]-[0063], and [0088]-[0090], the entire disclosure of which is hereby incorporated herein by reference in its entirety.

The OS 106 can include various types of operating systems such as Linux®, Windows®, macOS®, and hypervisor or hypervisor OS, among others. The network of jobs or processes can correspond to one or more compression domains, where compression is managed by the controller 103, via the help of the compression engine 10. However, it should be noted that a group of jobs or processes can be linked under a single compression domain. For example, a group of jobs or processes can use the same control block, and this group of jobs can collectively be referred to as a compression domain. Alternatively, a compression domain may also just include a single job or process.

A compression domain may correspond to a VM instance, such as AWS® EC2, Azure® VM, and any virtualized hardware environment created by a hypervisor (KVM, Xen®, VMware® ESXi, etc.). The memory 140 may be spliced into guest physical memory for each compression domain based on the expression of the OS 106 and management of the controller 103. For example, allocation of the memory 140 for a compression domain can be managed by the compression engine 10, which includes the backend microarchitecture 14 that can be configured to direct the controller 103 to map physical pages (e.g., physical pages of a memory managed by the OS 106) used by a compression domain to an allocated machine-physical memory (e.g., a portion of the memory 140) based at least in part on use of the shared states 12.

Referring to FIG. 2, the controller 103 and the compression engine 10 are connected between the memory 140 and various components of a processor including a core 232, a memory management unit (MMU) 234, and a cache 238. The cache 238, which can include one or more caches or cache levels, the MMU 234, and the contents of the MMU 234 (e.g., translation lookaside buffer (TLB) entries and their permission bits, etc.) remain generally unchanged from traditional systems because the compression engine 10 manages the memory 140 as a new layer that is independent from the virtual and physical memory layers. The transition from the core 232 and the MMU 234 occurs through virtual address (“VA”) translation, the transition from the MMU 234 to the cache 238 occurs through physical address (“PA”) translation, the transition from the cache 238 to the compression engine 10 occurs through PA translation, and the transition from the compression engine 10 to the memory 140 occurs through machine-physical address (“MPA”) translation, shown in legend 280.

The controller 103 including the compression engine 10 can be coupled to and/or positioned amongst the processor, and the compression engine 10 provides a direct hardware interface to enable the OS 106 to directly allocate the memory 140. Directly allocating the memory 140 can eliminate the need for sampling compression ratios (either at system or user level). Furthermore, allocating the memory 140 directly enables the OS 106 to allocate more to processes to which no more physical memory (e.g., memory managed by the OS 106) can be allocated.

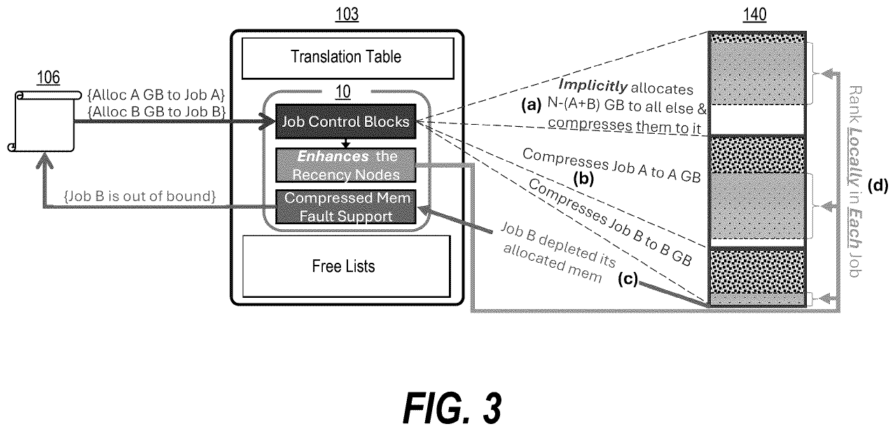

FIG. 3 depicts an overview of the compression engine 10 and how the compression engine 10 interacts with the OS 106 and the memory 140, according to various embodiments of the present disclosure. The contiguity in the memory 140 is shown for clarity and illustrative purposes only. The compression engine 10 enables the OS 106 to directly allocate the memory 140 to specific processes/jobs (e.g., one or more compression domains) that need precise allocation. For example, when jobs A and B specify A GB and B GB, the OS 106 can allocate via the compression engine 10 A GB and B GB of the memory 140 to them, respectively.

For processes/jobs that do not need precise memory allocation (for example, single user systems like desktops typically do not specify memory requirements for any process), the compression engine 10 can treat them collectively as one compression domain (e.g., compress them together). In hardware, the compression engine 10 can implicitly allocate to the compression domain all of the remaining portions of the memory 140, as seen in FIG. 3 at (a).

Like how different layers of memory are allocated (mostly) independently, machine-physical memory (e.g., the memory 140) allocation is mostly independent from physical memory allocation (e.g., does not care if 4 KB physical pages or huge pages are allocated). When the OS 106 allocates more physical pages to a process as it touches more virtual pages, the compression engine 10 can guide the controller 103 to compress allocated physical pages into allocated portions of the memory 140, as seen in FIG. 3 at (b).

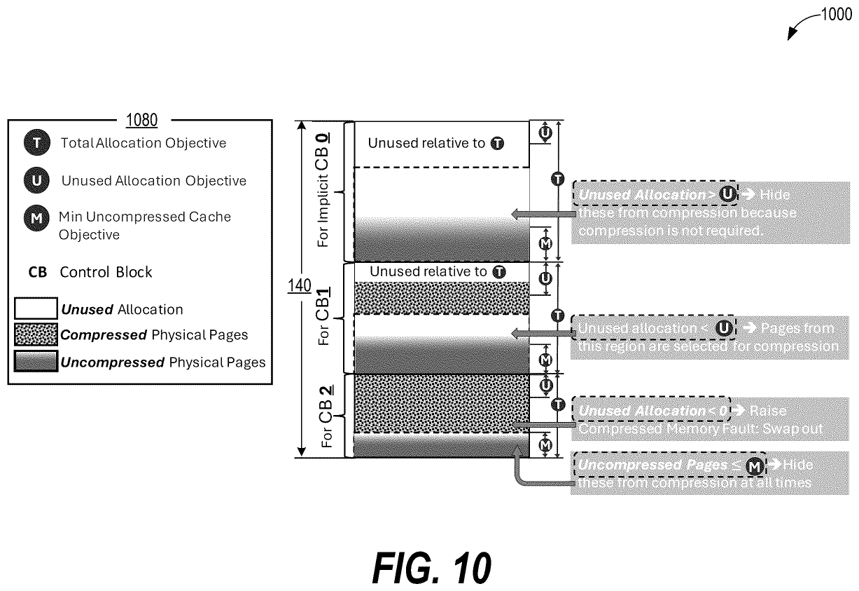

Physical memory allocation is affected when the allocated physical memory cannot fit in the allocated machine-physical memory. The compression engine 10 can raise a compressed memory fault, like a page fault, to alert the OS 106 (see FIG. 10 (c)) to deallocate some of the processes' physical pages (e.g., by spilling out some values) and cap how many physical pages to allocate to the process (e.g., allocate more only after deallocating more). Architecting a new MMU-like component to allocate machine-physical memory faces several challenges:

(1) MMU exposes a page-based allocation interface where an OS expresses which physical pages to allocate to a process by recording them in a page table and exposing the table to the MMU. Specifying which pages to allocate requires knowing which pages are free. However, when a memory controller transparently compresses physical pages to free up machine-physical memory, the OS does not know which machine-physical pages are free. The freed machine-physical pages can also soon be no longer free as the compression ratio fluctuates. Correctly cleaning up out-of-date OS records of pages previously exposed as free can be complex due to needing to handle various software-hardware race conditions.

(2) Specifying which machine-physical pages to allocate to each job restricts which machine-physical pages to use for the job. In comparison, prior works including traditional systems without precise allocation can store any data in any free location. Finding/tracking individually for each job the specific machine-physical locations the job is allowed to use can require complex changes to a MC. For example, hardware memory compression maintains many (e.g., 64) free lists, each to track free spaces of a different size to later use them to store compressed data of matching sizes. Maintaining for each job its own full collection of free lists to track free spaces within the specific machine-physical pages allocated to the job is complex.

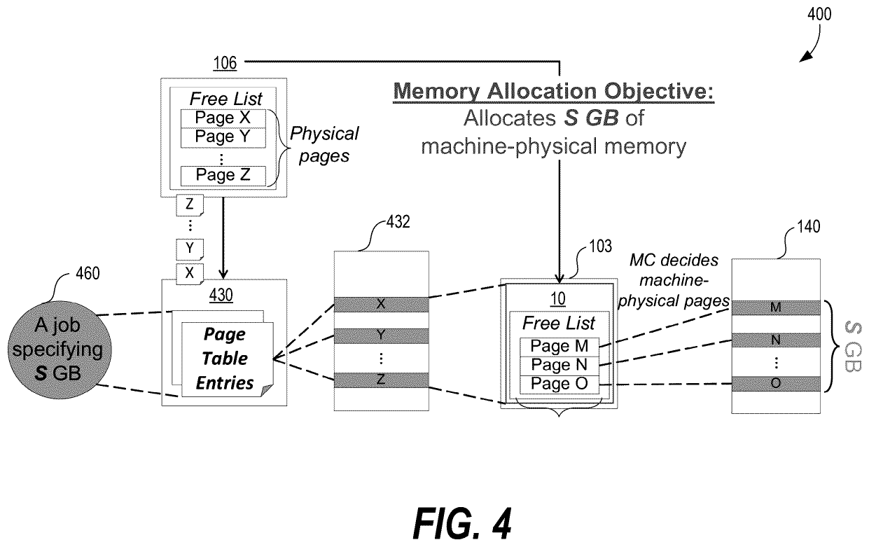

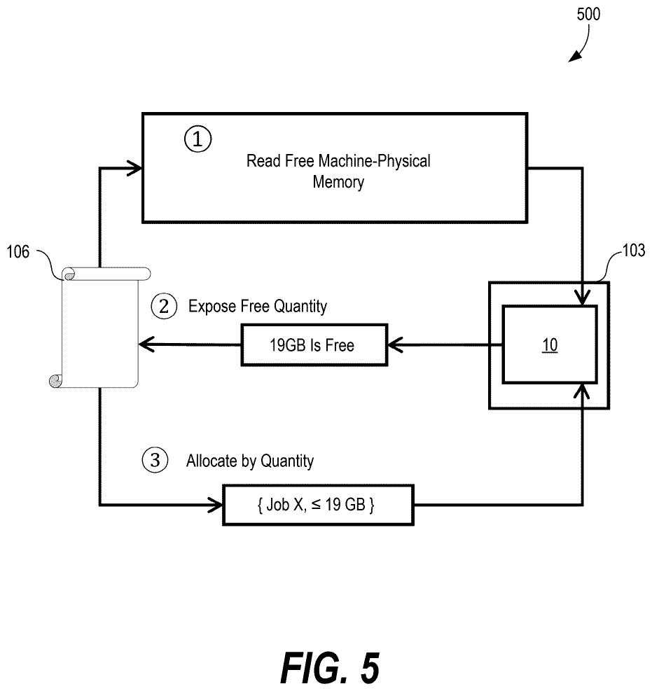

FIG. 4 depicts an objective based allocation process 400 implementable in the computing system 100, and FIG. 5 depicts a flowchart 500 summarizing the benefits of the objective based allocation process, according to various embodiments of the present disclosure. A page-based allocation expresses to hardware the higher-level objective of how much memory to allocate in an indirect manner. Collectively, the specified set of physical pages indirectly convey to hardware the total physical memory to allocate. Although indirect, specifying which physical page to allocate an OS to also specify which virtual page to use the page. Traditionally, this leads to a key benefit of the page-based allocation-relieving hardware from making decisions on virtual-to-physical address mappings, which helps keep hardware ‘dumb’ and simple.

In the context of hardware memory compression, which intelligently manages machine-physical memory, the key benefit of page-based allocation simply disappears. Hardware transparently compressing and packing data more densely requires hardware to actively decide machine-physical address(es) to use for each physical page. Rather than simplifying hardware, a page-based allocation method would complicate hardware. As such, instead of allocating machine-physical memory indirectly by specifying individual machine-physical pages, the compression engine 10 can implement the objective based allocation process 400 to enable the OS 106 to directly express high-level objectives of how much of the memory 140 to allocate.

Specifying how much machine-physical memory (e.g., the memory 140) to allocate generally only requires knowing how much machine-physical memory is free. Exposing to the OS 106 how much of the memory 140 is free is less complex and much faster than individually exposing which machine-physical pages are free. Furthermore, the OS 106 specifying high-level objectives, instead of micro managing which machine-physical pages to allocate, enables the controller 103 the freedom to store any data anywhere (e.g., among machine-physical pages (e.g., “Page M” . . . “Page O”) of the free list of machine-physical pages shown in FIG. 4). As such, the compression engine 10 can keep the same number of free lists as before.

The OS 106 can convey to the compression engine 10 high-level objectives (these objectives will be discussed in greater detail in the later figures) of how much machine-physical memory to allocate. The compression engine 10 can guide the controller 103 to meet or satisfy the memory allocation objectives. For example, the OS 106 may manage a free list of physical pages (e.g., “Page X” . . . “Page Z”) which may be mapped to page table entries 430 based on a request received from a job or process 460 specifying S GB. The OS 106 via the MMU 234 (see FIG. 2) and the page table entries 430 can map virtual addresses to physical addresses 432. Based on a memory allocation objective (e.g., “allocate S GB of machine-physical memory”) specified by the OS 106, the compression engine 10 can be configured to map one or more of the machine-physical pages (e.g., “Page M” . . . “Page O”) of the free list of machine-physical pages to the memory 140.

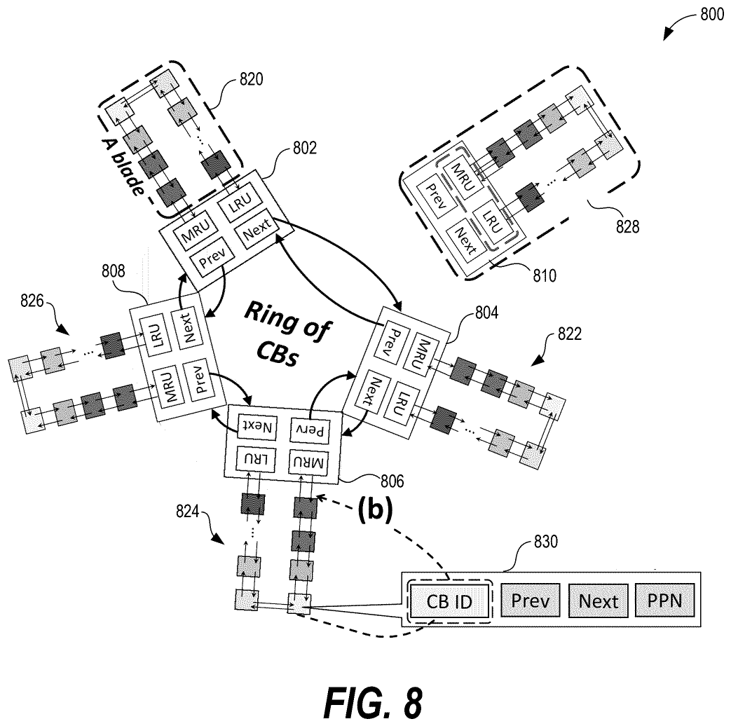

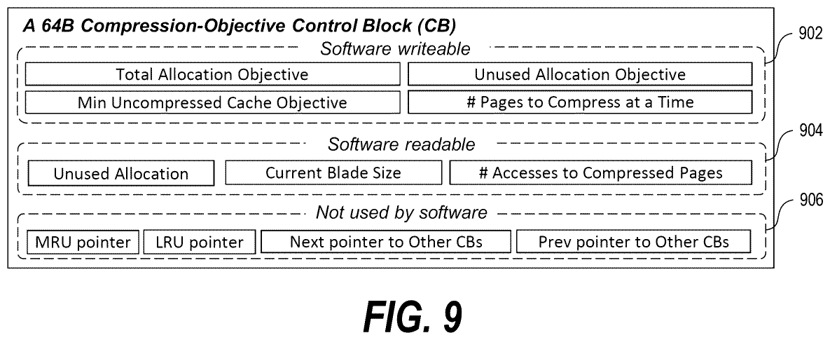

Referring to FIG. 5, at (1), the OS 106 can be configured to read free machine-physical memory from the memory 140 (see FIG. 1) by reading from OS-readable fields 904 (see FIG. 9) of a control block (e.g., corresponding to the control blocks 22 (see FIG. 1) or as shown in FIG. 8). The compression engine 10 can then be configured to expose a free quantity of the memory 140 to the OS 106 at (2). For example, the compression engine 10 can expose that 19 GB of memory 140 is free. The OS 106 can then set an allocation objective to be met for “Job X” and send these objectives to the compression engine 10. In this example, the OS 106 can specify that Job X should be allocated ≤19 GB as depicted, and this objective can be written to the shared states 12 (see FIG. 1), and particularly to the control blocks 22.

For expressing how much to allocate, unlike a page table, which can have many entries to record the set of allocated physical pages, the OS 106 can be configured to record the total machine-physical memory (e.g., of the memory 140) to a particular control block of the control blocks 22. A single control block can be 64 B or less and is also referred to herein as a “compression-objective control block” or “control block” for short. Each control block can contain an 8 B field referred to as the “total allocation objective field”. The total allocation objective field can record a single value (e.g., 19 GB) that can be increased or decreased at any granularity (e.g., 4 KB or 3 MB) through a single memory allocation.

Like a page table, which records the physical memory allocated to the virtual pages used by a process, each control block can be configured to record the machine-physical memory allocated to the physical pages used by a process. Since a control block is generally 64 B or less, the individual physical pages to be managed by the control block may need to be recorded elsewhere. Instead of adding more hardware data structures, the compression engine 10 can be configured to reuse recency nodes of each physical page by adding an OS-writeable “control block ID field” to each physical page, as will be shown and explained in greater detail with respect to the later figures. Recency nodes were selected to be used since having a control block ID field also enhances the recency nodes to rank recency locally within each job (see FIG. 3 at (d)).

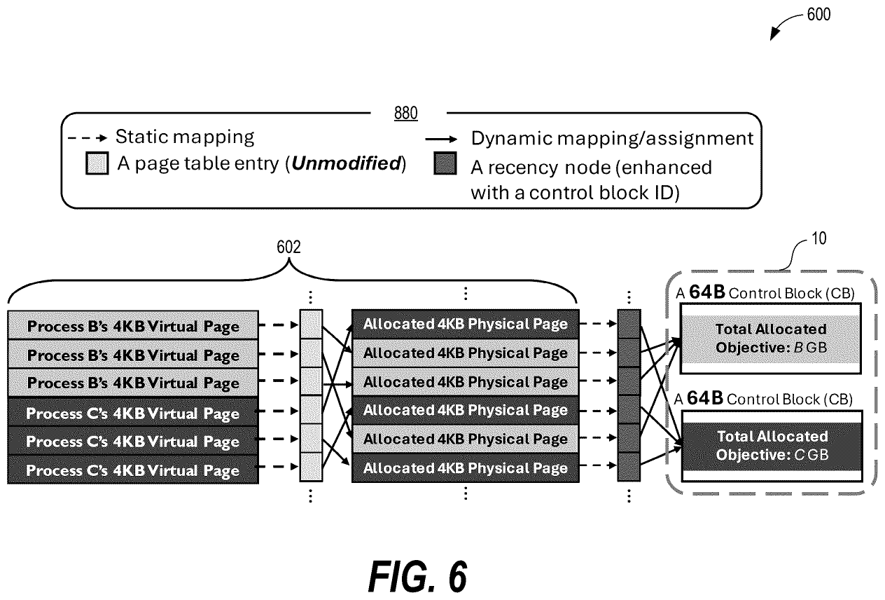

FIG. 6 depicts a diagram 600 of mappings between the compression engine 10 and physical and virtual pages for multiple processes according to various embodiments of the present disclosure. Mappings 602 include example static mappings between “Process B's” 4 KB virtual pages with page table entries (PTEs) of allocated 4 KB physical pages, as can be seen via arrows which are defined based on legend 880. Additionally, the mappings 602 include example static mappings between “Process C's” 4 KB virtual pages with page table entries (PTEs) of allocated 4 KB physical pages, as can be seen via arrows which are defined based on the legend 880. The mappings of each process's virtual page to physical page are in turn mapped to a recency node (e.g., of the recency nodes 20), which are in turn linked or mapped to a control block (e.g., corresponding to the control blocks 22 at FIG. 1 and as shown in FIG. 8), by way of the controller 103.

Additionally, the physical pages of each process (e.g., the “process B” or the “process C”) can share the “Total Allocated Objective” corresponding to a total allocation objective field recorded in a control block. While the OS 106 allocates a physical page to a process, the OS 106 can facilitate mapping the physical page to the control block mapped to the process by writing the control block's ID to the physical page's recency node. Core OS structures (e.g., virtual and physical memory allocators and page tables) remain intact because the compression engine 10 can manage the memory 140 as a new layer that is independent from prior virtual and physical memory layers.

The physical pages mapped to a control block (e.g., corresponding to the control blocks 22) can belong to a single process or belong to multiple processes or jobs. As such, a control block can serve to enforce an individual allocation of a single process/job or a joint objective across multiple jobs.

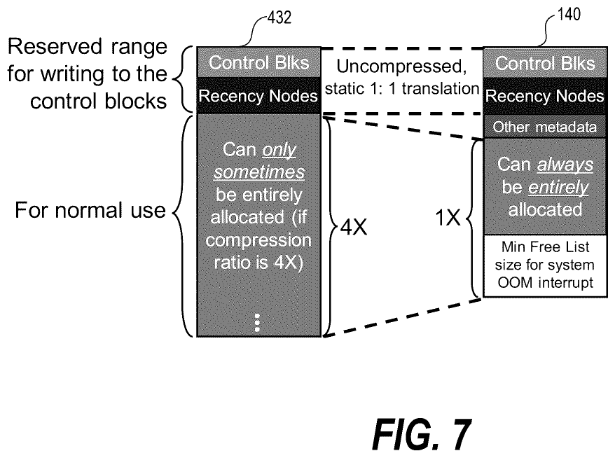

FIG. 7 depicts memory ranges of the physical memory 432 and the memory 140 according to various embodiments of the present disclosure. To expose the recency nodes 20 and the control blocks 22 to the OS 106, the compression engine 10 can be configured to map the recency nodes 20 and the control blocks 22 to a reserved physical memory range of the physical memory 432. The OS 106 can be configured to use existing software APIs to cause the address range to be uncacheable so that when the OS 106 writes to them, the stores go to memory and immediately affect the operations of the compression engine 10. Similar to how some fields are updated by the OS 106 in a PTE while others (e.g., the accessed and dirty bits) are updated by the MMU 234, the OS 106 and the compression engine 10 can be configured to update different fields within each control block and recency node.

FIG. 7 further shows the memory layout as can be managed by the compression engine 10. To support many jobs (e.g., 16384 jobs), each of the control blocks (corresponding to the control blocks 22) may only statically consume little (e.g., 16384·64B=1 MB) of the memory 140. “Other metadata” refers to other hardware data structures not managed by the compression engine 10, such as a translation table. Control blocks and recency nodes may be stored in the physical memory 432 and be mapped in a static 1:1 translation to the control blocks 22 and the recency nodes 20 in the memory 140.

Upon initialization of the compression engine 10, the compression engine 10 can be configured to map all physical pages to an initial control block or control block 0, which is also referred to herein as an “implicit control block.” Unlike other control blocks, to which the OS 106 can allocate a portion of the memory 140 by writing to the control block's total allocation objective field, the compression engine 10 can implicitly allocate a portion of the memory 140 to the implicit control block. The OS 106 can write to the total allocation objective field in the implicit control block once corresponding to the total of the memory 140 in the computing system 100 discovered from a BIOS to initialize the compression engine 10 after the OS 106 boots.

For exposing how much of the memory 140 is free, a key benefit of specifying how much of the memory 140 to allocate is that the compression engine 10 can be configured to expose to the OS 106 how much of the memory 140 is free instead of exposing which machine-physical pages of the memory 140 are free. Exposing how much of the memory 140 is free is fast and a low burden on resources. When the OS 106 can simply request to the compression engine 10 how much of the memory 140 is currently free to allocate right before each memory allocation (see FIG. 5 at (3)), without needing to record any previously-exposed free memory. This avoids having old OS records to clean up when the free memory exposed previously is no longer free (e.g., as compression ratios fluctuate).

Each control block can be configured to have an unused allocation field to dynamically track how much of the memory 140 allocated to a control block is currently unused. This field is generally read-only to software and updated by the compression engine 10. For example, when the controller 103 compresses a physical page and frees up Z bytes of the memory 140, the compression engine will arithmetically add Z to the unused allocation field of the control block to which the physical page is currently mapped. Table 1 below describes how the compression engine 10 updates the unused allocation field in the control block in the ways that are common across each of the control blocks 22, whether implicit or not.

TABLE 1

| | Machine- | |
|---|---|---|
| MC 103 and OS 106 | physical Mem | Unused |
| Actions | 140 | Allocation |
| MC compresses a physical | Z bytes freed | +=Z bytes |
| page. | | |
| MC spends more machine- | X bytes used | −=X bytes |
| physical memory on a | | |
| physical page (e.g., to make | | |
| a hot page uncompressed). | | |
| While allocating a physical | Y bytes used | −=Y bytes |
| page, OS maps the page to the | | |
| control block. | | |
| OS deallocates a physical | Y bytes freed | +=Y bytes |
| page that is currently | | |
| mapped to the control block. | | |

The unused allocation in the implicit control block exposes to the OS 106 how much of the memory 140 is currently ready to be allocated (see FIG. 5 at (1)). When the OS 106 allocates m more bytes to a control block i (i.e., by writing T+M to its total allocation objective, where T is the current value in this field), the compression engine 10 can be configured to subtract m from the implicit control block's unused allocation and adds m to the unused allocation of control block i. These simple arithmetic-based memory allocation operations allow the OS 106 to allocate in O(1) up to all of the unused allocation in the implicit control block.

If the host wishes to allocate to a job more of the memory 140 than there is currently available under the implicit control block's unused allocation, the OS 106 can ask the compression engine 10 to compress more pages to free up more memory to increase the unused allocation. In this respect, each control block can be configured to include an unused allocation objective field, and the compression engine 10 can be configured to asynchronously compress each control block's compression domain to increase the block's unused allocation to match this objective. This second objective is a best-effort target, rather than a rigorous “military” objective like total allocation objective. A compressed memory fault may be raised only if the latter is unmet, but not if the former is unmet.

Instead of increasing the implicit control block's unused allocation objective, the OS 106 can also increase other control blocks' unused allocation objectives and deallocate from them the freed portions of the memory 140. The unused allocation in a regular control block exposes to the OS 106 how much of the memory 140 can be deallocated from the block. After the OS 106 deallocates m bytes from a block (i.e., by writing T-m to its total allocation objective), the compression engine 10 subtracts m from the unused allocation and adds m to that of the implicit block.

Deallocating a portion of the memory 140 from a compression domain's control block corresponds to a potential deployment scenario where the host precisely “steals” from other compression domains that have over-specified their memory needs. For example, user profiling may not be always perfect and sometimes causes overspecification of memory. As such, a provider would have the option to “steal” a bit of memory that the user has specified/purchased.

To support the host with determining how much to “steal” from a compression domain's job without noticeably harming its performance, each control block contains a “# of Accesses to Compressed Pages” field to record how many of the accesses to the control block's physical pages are to compressed physical pages (e.g., of the physical memory 432 managed by the OS 106). The host may read this field to estimate the potential performance overhead on the control block's corresponding compression domain due to increasing the block's unused allocation objective. The host may use the “stolen” memory to cache more file pages for its own jobs. If a compression domain later needs the “stolen” portion of the memory 140, the host may evict the file pages to free up the portion to reallocate back to the compression domain associated with the user.

For allocating minimum uncompressed memory, when a job or compression domain runs low on uncompressed physical pages, the job can slow down significantly as most accesses will be to compressed pages. In this case, leaving more of the recently-used physical pages uncompressed may be better even if this requires spilling more virtual pages or file pages to storage. As such, each control block also supports an objective of how many recently-accessed pages to leave uncompressed at a minimum. Leaving recently-accessed pages uncompressed essentially creates a fast cache. As such, this objective is referred to herein as the “Min Uncompressed Cache Objective” or minimum uncompressed cache objective. Setting the minimum uncompressed cache objective to 100 MB in a control block functionally creates for the block a private LA cache with a minimum of 100 MB. Only pages that are deliberately left uncompressed after recent accesses to them (as opposed to incompressible pages) count towards meeting this minimum uncompressed cache objective.

FIG. 8 depicts a ring 800 of control blocks implementable in the computing system 100, and FIG. 9 depicts various fields contained in a single control block, according to various embodiments of the present disclosure. The ring 800 of control blocks can also be referred to herein as a “ring of control blocks” and includes a first control block 802, a second control block 804, a third control block 806, a fourth control block 808, and a fifth control block 810. The control blocks 802-808 are representative of a plurality of control blocks that can be a part of the control blocks 22 shown in FIG. 1. The control block 810 is detached from the ring, which will be discussed in greater detail below.

Additionally, uncompressed physical pages of a physical memory (e.g., the physical memory 432) can be mapped to each control block. That is, the controller 103 can be configured to map the uncompressed physical pages of the physical memory 432 to the control blocks 802-808, for example. Each physical page can contain or be mapped to a recency node (e.g., corresponding to the recency nodes 20), and the linked list of recency nodes attached to a control block can form a “blade.” For example, a physical page in blade 824 can contain a recency node 830, which includes a control block ID (“CB ID”) pointer, a previous node (“PREV”) pointer, a next node (“NEXT”) pointer, and a physical page number (“PPN”) pointer. The controller 103 can be configured to map blades to control blocks. For example, the controller 103 can map blade 820 to the control block 802, map blade 822 to the control block 804, map the blade 824 to the control block 806, map blade 826 to the control block 808, and map blade 828 to the control block 810.

Referring to FIG. 9, each of the control blocks 802-810 can include OS-writeable objective fields 902, such as a “total allocation objective field,” an “unused allocation objective field,” a “min uncompressed cache objective field,” and a “#pages to compress at a time” objective field. These objective fields have been discussed above in previous paragraphs. Each control block can also include OS-readable fields 904, such as an “unused allocation” field, a “current blade size” field, and a “#accesses to compressed pages” field. Each control block can also include pointers 906 that are not used by the OS 106, such as a most recently used (MRU) pointer, a least recently used (LRU) pointer, “next pointer to other CBs,” and “prev pointer to other CBs.” The compression engine 10 can be configured to analyze each of the control blocks 802-810 in a round-robin fashion to determine whether any physical pages need to be compressed based on the allocation objectives written in the OS-writeable objective fields of each control block.

After the OS 106 allocates portions of the memory 140 (see FIG. 1) to a process or compression domain via the compression engine 10, the compression engine 10 can guide the controller 103 to compress mapped physical pages into the allocated portion of the memory 140. The select physical pages to compress in each compression domain should be the compression domain's coldest pages.

Traditionally, each VM or control group (Cgroup) has its own thread (e.g., swap daemon) to rank the recency of the virtual pages in the VM or Cgroup and can use it to select victim pages. Ranking recency locally within individual VMs or Cgroups (as opposed to globally across all VMs or Cgroups) prevents the swap daemon from excessively swapping out from a VM/Cgroup that is less memory-intensive than another co-located VM/Cgroup. But giving each control block its own compression scheduling hardware, like having its own LRU/swap thread in each VM/Cgroup, can incur costly hardware overhead. As such, a key design concept that was considered is determining how to share a similar or same compression scheduling logic across all control blocks.

In consideration of this design concept, the compression engine 10 can be configured to combine the control blocks 802-810 and the blades 820-828 into the ring 800, which is a single cohesive fan-like structure. The compression engine 10 can be configured to asynchronously walk the fan to schedule compression to ensure that for each compression domain (e.g., corresponding to each control block of the control blocks 802-808), compress only as many colder pages as needed. Across each compression domain, the ASIC compressor (e.g., corresponding to the hardware memory compressor 26 in FIG. 1) is used fairly.

To select the coldest page in a compression domain, the compression engine 10 can be configured to add to each control block an LRU pointer and an MRU pointer to point to the recency node of the LRU page and the MRU page, respectively, among all uncompressed physical pages currently mapped to the block. Each control block uses these two pointers to connect transitively to all recency nodes of all the uncompressed physical pages that are currently mapped to the block. These recency nodes together form a blade (e.g., corresponding to the blades 820-828) in the “fan.”

Unlike other works which have a single global linked list containing the recency nodes of all uncompressed pages, each blade can include a smaller linked list that only contains the recency nodes of the uncompressed physical pages mapped to one control block. When the OS 106 writes a new CB ID in a recency node (see FIG. 6), the compression engine 10 can join the recency node to the control block's blade if the physical page is currently uncompressed.

To rank recency locally within a blade, for every 100^{th} normal memory request, the compression engine 10 can be configured to logically move a recency node of the accessed page to the head (MRU end) of a blade (see FIG. 8 (b)) and, thus, logically “shifts” all other recency nodes towards the tail (LRU) end. If the accessed page is compressed, the compression engine 10 only joins the recency node of the page to the blade after the page is reverted to an uncompressed format.

To obey allocation objectives, the compression engine 10 can add pointers (e.g., the pointers 906 (see FIG. 9)) to each control block to connect to other control blocks in a ring that forms a wheel of the fan in FIG. 8. The compression engine 10 only selects for compression physical pages that are currently mapped to control blocks in the ring. The compression engine 10 can be configured to dynamically detach a control block (e.g., the control block 810) from the ring according to the objectives of the control block. For example, the compression engine 10 can be configured to detach a control block when: unused allocation >unused allocation objective OR 4 KB*current blade size ≤minimum uncompressed cache objective.

To schedule compression, the compression engine 10 can be configured to fairly round robin through each of the control blocks 802-808 continuously in the background, as mentioned above. When accessing a control block, the compression engine 10 can direct the controller 103 to compress an OS-configurable number of physical pages recorded in the recency nodes at the LRU end of the block's blade. This configurable number (e.g., “pages to compress during a visit”) is recorded in each control block. After compressing a physical page, the compression engine 10 can be configured to remove the page's recency node from the corresponding blade. If the page turns out to have a low compression ratio (e.g., <1.15×), the compression engine 10 can leaves it uncompressed, but the compression engine 10 can still removes the corresponding recency node from the blade to avoid uselessly compressing it again shortly after.

When a compression domain cannot be compressed and stored into an allocated portion of the memory 140 (i.e., when its unused allocation drops to negative), the compression engine 10 can raise a compressed memory fault. This is similar to when an MMU cannot store a process's values into the process's allocated physical memory (e.g., when the process writes to a virtual page without a physical page), the MMU raises a page fault to prevent the store from using more physical memory and to alert the OS.

But unlike page faults in MMUs, which prevent faulting stores from using more memory by aborting them (i.e., deleting their values) and re-executing them later, writebacks cannot be re-executed as they can take place arbitrarily long after their original stores. As such, the compression engine 10 can be configured to serve faulting writebacks and following writebacks, causing the control block's unused allocation to be more negative by using more memory. The compression engine 10 can implicitly “borrow” memory from an implicit control block by reducing the implicit control block's unused allocation by the same amount. Conversely, whenever a negative unused allocation increases, the compression engine 10 increases the implicit block's unused allocation by the same amount to “return” the “borrowed” memory.

The compressed memory fault is an asynchronous interrupt. To avoid interrupt storms, the compression engine 10 can raise an interrupt once when an unused allocation flips negative, instead of continuously interrupting while the unused allocation remains negative. The compressed fault handler routine can then spill out some of the faulting compression domain's values and can also cap (e.g., via Cgroups) how many physical pages to allocate to the compression domain (i.e., allocate more physical pages to the compression domain only after deallocating more from it).

The handler need not pause the compression domain if the handler can ensure the compression domain will not keep growing in an unbounded manner when the compression domain keeps running. To ensure this, the compression domain can first allocate a grace amount (e.g., 10 MB) of machine-physical memory to the control block to make its unused allocation positive. If the handler receives another compressed memory fault due to the unused allocation flipping negative again, only then will the handler pause the control block's compression domain. Later, when the spilling of the compression domain's values causes the unused allocation to rise above 2× the grace amount, the handler deallocates 1X the grace amount to restore the original machine-physical allocation.

The alternative of page-based allocation, which slowly allocates one page at a time, would require pausing the compression domain after the very first fault. Otherwise, there is the risk that the compression domain may grow faster than the slow memory allocation and make the unused allocation stay negative constantly, which would prevents the unused allocation from flipping negative (note that flipping negative require first turning positive). Preventing the unused allocation from flipping negative would prevent a second fault from ever getting raised.

FIG. 10 depicts a diagram 1000 of how the compression engine 10 can enforce memory allocation objectives according to various embodiments of the present disclosure. For example, the compression engine 10 can be configured to enforce three memory allocation objectives: the total allocation objective, the unused allocation objective, and the minimum allocation objective, as shown in legend 1080. These objectives correspond to the OS-writeable objective fields in each control block as shown in FIG. 9. Unused allocations in the memory 140 are analyzed by the compression engine 10 and compared to the allocation objectives, thereby causing actions to be performed by the compression engine 10, as laid out in FIG. 10.

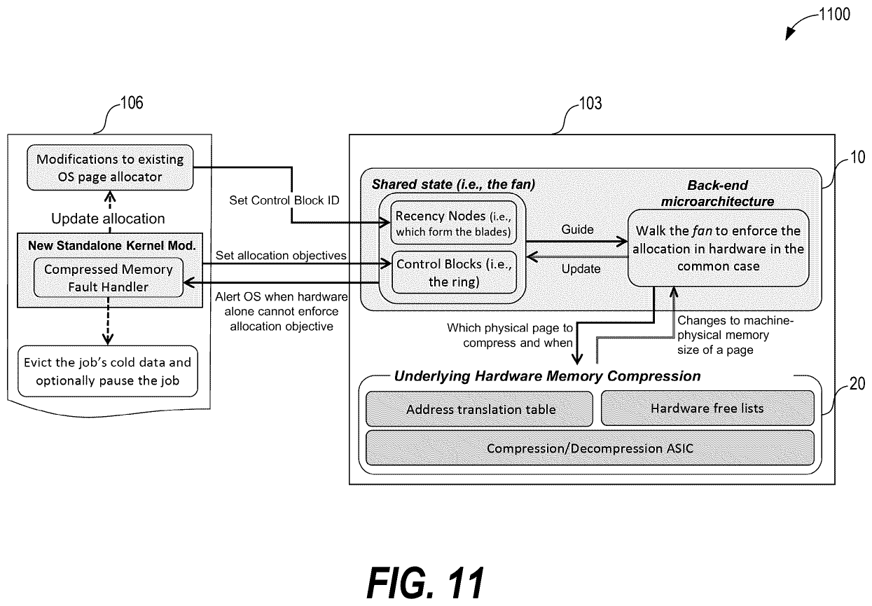

FIG. 11 depicts a computing system 1100 for multi-domain hardware memory compression, with summarized interactions between the controller 103 and the OS 106, according to various embodiments of the present disclosure. The OS 106 can be configured to execute modifications to an existing OS page allocator, which can set control block IDs for recency nodes (e.g., the recency nodes 20 (see FIG. 1)). The OS 106 can include a standalone kernel module which can include a compressed memory fault handler. The kernel module can update allocation for the OS page allocator and also evict a job or compression domain's cold data and optionally pause the job. The kernel module can set allocation objectives (e.g., write allocation objectives) to control blocks (e.g., the control blocks 22 (see FIG. 1)) of the compression engine 10. In response, the compression engine 10 can alert the OS 106 when hardware alone cannot enforce the allocation objectives.

Shared states in the compression engine 10, which include the recency nodes and the control blocks, can guide a back-end microarchitecture (e.g., the backend microarchitecture 14 (see FIG. 1)) to walk the fan (e.g., see FIG. 8) to enforce the allocation objectives in hardware. The back-end microarchitecture can also be configured to update the recency nodes and/or the control blocks in the shared states.

The controller 103 can further include underlying hardware memory compressors such as the hardware memory compressor 26 shown in FIG. 1. The hardware memory compressor in the controller 103 can include address translation tables, hardware free lists, and various compression/decompression ASICs. The hardware memory compressor can be configured to cause changes to the size of pages of a machine-physical memory (e.g., the memory 140) via the back-end microarchitecture, and the back-end microarchitecture can direct the hardware memory compressor to compress which physical page that is mapped to a control block being accessed by the compression engine 10.

For multiple memory controllers such as Intel® Xeon® CPUs, these CPUs can have two memory controllers (MCs), each controlling multiple channels. In this case, different 4 KB physical pages can be interleaved across MCs and individual 4 KB page can be interleaved across all channels within the same MC. To allocate N bytes of machine-physical memory, the OS 106 can write the total allocation objective twice, each to a different MC's compression engine 106 to allocate N/2 bytes of machine-physical memory.

For shared pages, different jobs can share the same physical page (e.g., a C library page). However, each physical page can only be mapped to one control block at a time because each recency node records only one control block ID. As such, each shared physical page is “charged” to one control block, like how Linux® “charges” a shared physical memory only to one Cgroup. Alternatively, the OS 106 may map all shared physical pages used by different jobs to a common control block and allocate to the block enough machine-physical memory (e.g., of the memory 140) so all shared pages stay uncompressed. However, it should be noted that shared pages need not be compressed because any degree of sharing already equates to high compression. The OS 106 can then decrease the total allocation objective in each job's control block by the number of shared physical pages the job is using (i.e., decrease the allocation objective by the same number of machine-physical pages).

For VMs, the compression engine 10 can work similarly except with some differences when a VM runs out of memory. The compressed memory fault handler can call the hypervisor to invoke a balloon driver inside the VM. Balloon drivers are extensively used by hypervisors today to reclaim memory from VMs. The balloon driver inflates a memory balloon, which uses up the pseudo-physical memory inside the VM and spills the VM's data to the VM's file system or swap space.

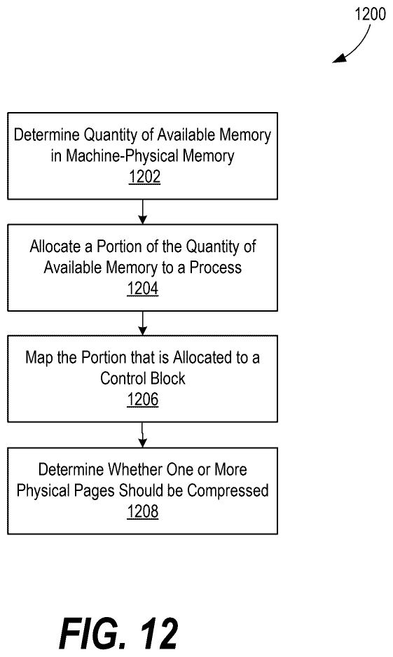

FIG. 12 depicts an example method 1200 for multi-domain hardware memory compression that can be implemented by the controller 103 according to various embodiments of the present disclosure. At step 1202, the controller 103 can be configured to determine a quantity of available memory in a machine-physical memory such as the memory 140. For example, referring to FIGS. 1 and 5, the compression engine 10 may receive instructions from the OS 106 to read how much free machine-physical memory there is in the memory 140, and the compression engine 10 can expose the quantity of available memory to the OS 106.

At step 1204, the controller 103 can be configured to allocate a portion of the quantity of available memory to a process (e.g., corresponding to one or more jobs or a compression domain). For example, to allocate the portion of the quantity of available memory to the process, the controller 103 can be configured to determine a free list of machine-physical pages in the memory 140, and map the portion to one or more pages of the free list of machine-physical pages. The controller 103 can further be configured to map the one or more pages of the free list to a plurality of physical pages used by the process.

At step 1206, the controller 103 can be configured to map the portion that is allocated to the process to a control block among a plurality of control blocks. For example, the portion of the memory 140 that is allocated to the process can be mapped to one or more of the control blocks 22 (see FIG. 1). Additionally, the controller 103 can be configured to map the plurality of physical pages used by the process to the control block. The controller 103 can also map a plurality of recency nodes associated with the plurality of physical pages to the control block, where the recency nodes help facilitate determination of a recency of access of the plurality of physical pages.

At step 1208, the controller 103 can be configured to determine whether one or more physical pages of the plurality of physical pages should be compressed based at least in part on an OS-writeable objective field contained in the control block. The OS-writeable objective fields can include various objective fields such as one or more of: a total allocation objective field, a minimum uncompressed cache objective field, an unused allocation objective field, or a number (#) of pages to compress at a time objective field (see FIG. 9). These objective fields can be written in to the control block by the OS 106.

With reference to FIGS. 8 and 9, the compression engine 10 can be configured to guide the controller 103 to compress the mapped physical pages into the allocated portion of the memory 140. The select physical pages to compress in each compression domain should be the compression domain's coldest pages. For example, each mapped physical page of a control block can be ranked based on recency of access via the recency nodes in each physical page. Thereafter, the coldest physical page can be selected and compressed into the allocated portion of the memory 140 to satisfy one or more of the OS-writeable objective fields in the memory block.

The concepts described herein can be combined in one or more embodiments in any suitable manner, and the features discussed in the embodiments are interchangeable in some cases. Example embodiments are described herein, although a person of skill in the art will appreciate that the technical solutions and concepts can be practiced in some cases without all of the specific details of each example. Additionally, substitute or equivalent steps, components, materials, and the like may be employed.

The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or metric of deviation, account for at least some manufacturing tolerances between a theoretical design and a manufactured product or assembly. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The flowchart of FIG. 12 is the functionality and operation of an implementation of portions of an application executed by processing circuitry or at least one hardware processor, such as in the controller 103. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor (e.g., a hardware processor) in a computer system or other system. The machine code may be converted from the source code, etc. If embodied in hardware, each block may represent a circuit or a number of interconnected circuits to implement the specified logical function(s).

Although the flowchart of FIG. 12 shows a specific order of execution, it is understood that the order of execution may differ from that which is depicted. For example, the order of execution of two or more blocks may be scrambled relative to the order shown. Also, two or more blocks shown in succession in FIG. 12 may be executed concurrently or with partial concurrence. Further, in some embodiments, one or more of the blocks shown in FIG. 12 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, at least the following is claimed:

1. A computing system, comprising:
one or more memories; and
a controller configured to manage allocation of the one or more memories to a process based on one or more memory allocation objectives received from an operating system (OS), wherein to manage allocation of the one or more memories to the process, the controller is further configured to:
determine a quantity of available memory in the one or more memories;
allocate a portion of the quantity of available memory to the process;
map the portion that is allocated to the process to a control block among a plurality of control blocks;
map a plurality of physical pages used by the process to the control block, the plurality of physical pages being associated with a memory managed by the OS; and
determine whether one or more physical pages of the plurality of physical pages should be compressed based at least in part on an OS-writeable objective field contained in the control block.

2. The computing system of claim 1, wherein to allocate the portion of the quantity of available memory to the process, the controller is further configured to:
determine a free list of machine-physical pages in the one or more memories;
map the portion to one or more pages of the free list of machine-physical pages; and
map the one or more pages of the free list to the plurality of physical pages.

3. The computing system of claim 2, wherein to allocate the portion of the quantity of available memory to the process, the controller is further configured to:
determine a plurality of recency nodes associated with the plurality of physical pages; and
map the plurality of recency nodes to an identification of the control block.

4. The computing system of claim 3, wherein the plurality of recency nodes and the control block are mapped to a reserved physical memory range associated with the memory managed by the OS.

5. The computing system of claim 2, wherein to manage allocation of the one or more memories to the process, the controller is further configured to:
map a plurality of available physical pages to an implicit control block among the plurality of control blocks, the implicit control block corresponding to an initial control block, and the plurality of available physical pages being associated with the memory managed by the OS; and
map the free list of machine-physical pages to the implicit control block.

6. The computing system of claim 1, wherein the controller is further configured to rank a recency of access of the plurality of physical pages used by the process based on a least recently used (LRU) pointer and a most recently used (MRU) pointer contained in the control block.

7. The computing system of claim 1, wherein the control block comprises 64 bytes (B) or less.

8. The computing system of claim 1, wherein the OS-writeable objective field comprises a total allocation objective field.

9. The computing system of claim 8, wherein the total allocation objective field is 8 B or less.

10. The computing system of claim 1, wherein the one or more memories comprise dynamic random access memory (DRAM).

11. The computing system of claim 1, wherein the OS-writeable objective field comprises a minimum uncompressed cache objective field, the minimum uncompressed cache objective field corresponding to a quantity of the plurality of physical pages to remain uncompressed.

12. The computing system of claim 1, wherein the OS-writeable objective field comprises an unused allocation objective field, the unused allocation objective field corresponding to an unused quantity of the portion that is allocated to the process.

13. A computing system, comprising:
one or more memories; and
a controller configured to manage allocation of the one or more memories to a process based on one or more memory allocation objectives received from an operating system (OS), wherein to manage allocation of the one or more memories to the process, the controller is further configured to:
determine a quantity of available memory in the one or more memories;
allocate a portion of the quantity of available memory to the process;
map the portion that is allocated to the process to a control block among a plurality of control blocks;
map a plurality of physical pages used by the process to the control block, the plurality of physical pages being associated with a memory managed by the OS; and
determine whether the plurality of physical pages should be compressed based at least in part on a plurality of OS-writeable objective fields contained in the control block and a recency of access scheme associated with the plurality of physical pages.

14. The computing system of claim 13, wherein the recency of access scheme is associated with a least recently used (LRU) pointer and a most recently used (MRU) pointer contained in the control block.

15. The computing system of claim 14, wherein the recency of access scheme is associated with the controller being configured to move a recency node of a recently accessed physical page of the plurality of physical pages toward the MRU pointer.

16. The computing system of claim 13, wherein to allocate the portion of the quantity of available memory to the process, the controller is further configured to:
determine a free list of machine-physical pages in the one or more memories;
map the portion to one or more pages of the free list of machine-physical pages; and
map the one or more pages of the free list to the plurality of physical pages.

17. The computing system of claim 13, wherein the controller is further configured to manage allocation of the one or more memories to a second process based on the one or more allocation objectives received from the OS, the second process being similar to the process, the controller configured to schedule compression between the process and the second process based at least in part on a round robin scheduling method.

18. The computing system of claim 13, wherein the plurality of OS-writeable objective fields comprises a total allocation objective field, a minimum uncompressed cache objective field, and an unused allocation objective field.

19. A method for managing allocation of one or more memories to a process based on one or more memory allocation objectives received from an operating system (OS), the method comprising:
determining a quantity of available memory in the one or more memories;
allocating a portion of the quantity of available memory to the process;
mapping the portion that is allocated to the process to a control block among a plurality of control blocks;
mapping a plurality of physical pages used by the process to the control block, the plurality of physical pages being associated with a memory managed by the OS; and
determining whether one or more physical pages of the plurality of physical pages should be compressed based at least in part on an OS-writeable objective field contained in the control block.

20. The method of claim 19, wherein the OS-writeable objective field contained in the control block comprises a selection of: a total allocation objective field, a minimum uncompressed cache objective field, or an unused allocation objective field.
